(19) United States
(12) Patent Application Publication
(10) Pub. No.: US 2021/0170624 A1
(43) Pub. Date: Jun. 10, 2021

(54) TREATED LAMINATED VENEER LUMBER AND METHOD OF MAKING SAME

(71) Applicant: JOIBEAM, LLC, Pinconning, MI (US)

(72) Inventors: Larry VanMullekom, Bay City, MI (US); Dave Nethers, Pinconning, MI (US)

(73) Assignee: JOIBEAM, LLC, Pinconning, MI (US)

(21) Appl. No.: 16/707,591

(22) Filed: Dec. 9, 2019

(51) Int. Cl. B27K 3/32; B32B 21/14; B32B 21/13; B27K 3/08; B27K 3/22; B27D 1/00

(52) U.S. Cl. CPC B27K 3/32; B32B 21/14; B32B 21/13; B27K 3/086; B27K 2200/30; B27D 1/00; B32B 2260/026; B32B 2260/04; B27K 3/22

(57) ABSTRACT

A method of making treated laminated veneer lumber (LVL) according to one example of the present disclosure includes obtaining assembled LVL. The assembled LVL comprises a plurality of layers of veneer wood assembled together with adhesive. The LVL is loaded into a pressure chamber. A vacuum is created in the pressure chamber thereby removing air from the plurality of layers of veneer wood of the LVL. Inorganic solution is added into the pressure chamber. The pressure chamber is pressurized to force the inorganic solution into the wood creating the treated LVL.

### FIELD

The present disclosure relates generally to lumber and more particularly to laminated veneer lumber that has been specifically treated after assembly and a related method for making the same.

### BACKGROUND

Laminated veneer lumber (LVL) is an engineered wood product that uses multiple layers of thin wood assembled with adhesives. LVL is typically used for headers, beams, rafters, rim board and edge-forming material. LVL can be preferred over typical milled lumber in many instances. For example, LVL is manufactured to controlled specifications. In this regard, LVL can be manufactured to be stronger, straighter and more uniform as compared to conventional solid milled lumber. Further, due to its composite nature, LVL is much less likely than conventional lumber to warp, twist, bow or shrink.

While LVL can be useful in many applications a need still exists in the art to provide improvements. For example, LVL is typically installed in interior environments that are not exposed to weather. In addition, a need exists to provide a straighter, stronger and more consistent lumber solution that is simpler to make and can be readily applied to a wider range of applications.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method of making treated laminated veneer lumber (LVL) according to one example of the present disclosure includes obtaining assembled LVL. The assembled LVL comprises a plurality of layers of veneer wood assembled together with adhesive. The LVL is loaded into a pressure chamber. A vacuum is created in the pressure chamber thereby removing air from the plurality of layers of veneer wood of the LVL. Inorganic solution is added into the pressure chamber. The pressure chamber is pressurized to force the inorganic solution into the wood creating the treated LVL.

According to additional features, a predetermined amount of time is passed subsequent to pressurizing the pressure chamber to allow the inorganic solution to sufficiently absorb into the LVL. In one example, the predetermined amount of time is greater than 30 minutes. In another example, the predetermined amount of time is greater than 35 minutes. In still other examples, LVL can be successfully penetrated through the thickness of the LVL during pressure treatment in less time, such as but not limited to, 6 minutes. The inorganic solution is removed from the pressure chamber subsequent to waiting the predetermined amount of time. A vacuum is created in the pressure chamber subsequent to removing the inorganic solution from the pressure chamber.

In other features, the treated LVL is removed from the pressure chamber and placed onto a concrete pad for drying. Adding the inorganic solution can include adding a solution that includes at least one of micronized copper azole (MCA), copper azole (CA), ammoniacal copper quaternary (ACQ), ammoniacal copper zinc arsenate (ACZA) and chromatid copper arsenate (CCA). In one example, adding the inorganic solution comprises adding a solution that comprises all of the MCA, CA, ACQ, ACZA and CCA. In still other examples, the inorganic solution can additionally or alternatively include other vacuum pressure waterborne inorganic chemicals.

A treated laminated veneer lumber (LVL) according to the present disclosure is provided. The treated LVL comprises an assembled LVL treated with an inorganic solution in a pressure chamber. The inorganic solution is penetrated through an entire thickness of the assembled LVL. In some examples, the inorganic solution comprises a solution that includes at least one of micronized copper azole (MCA), copper azole (CA), ammoniacal copper quaternary (ACQ), ammoniacal copper zinc arsenate (ACZA) and chromatid copper arsenate (CCA). In one example, the inorganic solution comprises all of MCA, CA, ACQ, ACZA and CCA. The CA can comprise type A and B. The ACQ can comprise type B and C. The CCA can comprise type A, B and C.

### BRIEF DESCRIPTION OF THE DRAWINGS

The present disclosure will become more fully understood from the detailed description and the accompanying drawings, wherein:

FIG. 1 is a perspective view of a deck framework constructed with conventional lumber according to one Prior Art example;

FIG. 2 is perspective view of a deck framework incorporating treated LVL formed by the present teachings and constructed in accordance to one example of the present disclosure;

FIG. 3 is a sequence view of forming conventional LVL according to one Prior Art example;

FIG. 4 is a sequence view of making treated LVL according to one example of the present disclosure;

FIG. 5 is a perspective view of a treating process system wherein assembled LVL is placed into a vacuum pressure chamber and treated in accordance to one example of the present disclosure; and

FIG. 6 is a method of forming treated LVL according to one example of the present disclosure.

### DETAILED DESCRIPTION

As will become appreciated from the following discussion, the present disclosure provides a treated LVL that is created using a novel method. While not so limited, the treated LVL disclosed herein is particularly useful in outdoor applications, such as but not limited to, deck framing. While traditional LVL has been successfully used in many applications such as indoor framing, such LVL is not particularly suited for outdoor use where weather elements such as moisture and sun can degrade the LVL over time. Moreover, other treated LVL offerings incorporate organic treatments and involve multiple steps for treating each layer of wood prior to assembly.

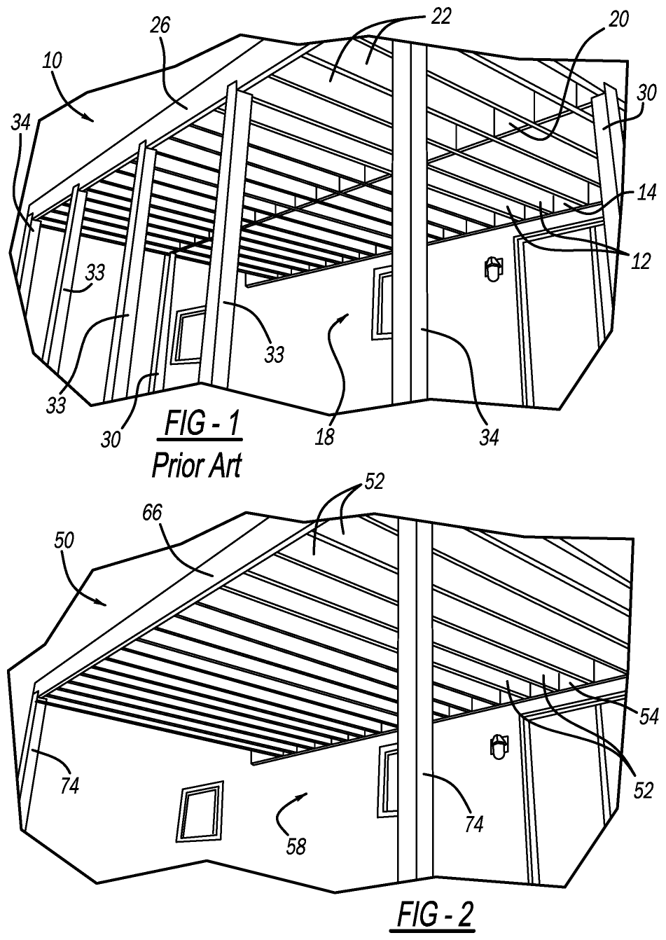

With initial reference to FIG. 1, a deck frame constructed in accordance to one prior art configuration is shown and generally identified at reference numeral 10. The deck frame 10 can include a first plurality of joists 12 extending horizontally from a ledger 14 fixed to a house structure 18. The first plurality of joists 12 extend laterally from the ledger 14 to an intermediate beam 20. A second plurality of joists 22 extend laterally from the intermediate beam 20 to an outer beam or rim joist 26. Intermediate posts 30 extend vertically from the intermediate beam 20 and can be secured to ground such as by way of concrete footings (not specifically shown). Outer posts 34 and interior posts 33 extend vertically from the outer beam 26 and can be secured to ground similar to the intermediate posts 30. The deck frame 10 according to prior art can incorporate traditional joists 12 that are made from treated milled lumber.

Turning now to FIG. 2, a deck frame constructed in accordance to one example of the present teachings is shown and generally identified at reference numeral 50. The deck frame 50 can include a plurality of joists 52. The plurality of joists 52 extend horizontally from a ledger 54 fixed to a house structure 58 to an outer beam 66. Outer posts 74 extend vertically from the outer beam 66 and can be secured to ground. The plurality of joists 52, ledger 54 and outer beam 66 are all treated LVL formed by the method disclosed in the instant application. In one advantage over the deck frame 10 that incorporates conventional milled lumber, the plurality of joists 12 of the deck frame 50 are stronger. In this regard, the intermediate beam 20 used in the traditional frame 10 is eliminated. As such, the plurality of joists 12 can span further away from the house structure 58 all the way to the outer beam 66. Additionally, intermediate posts, such as posts 30, as well as interior posts 33 used in the traditional frame 10 are eliminated. The deck frame 50 incorporating the joists 52 formed from the novel method herein provides a straighter, stronger and generally more robust deck frame requiring less structural components over conventional deck frames. Because reduced amounts of joists are required to span extended lengths, deck frame designs are less constrained.

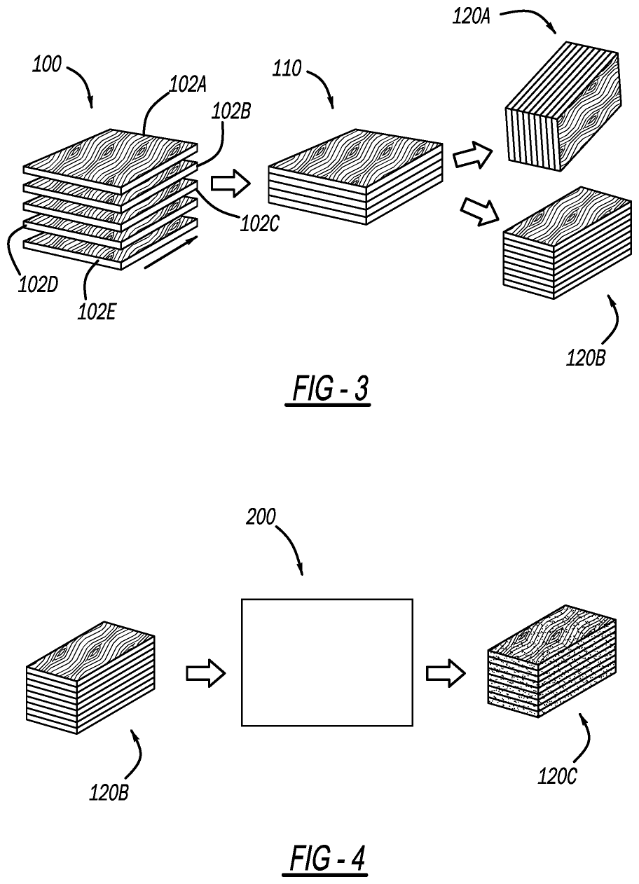

Turning now to FIG. 3, a process for making assembled LVL according to prior art is shown. As is known, LVL comprises multiple layers of wood veneers collectively shown at reference 100 and individually identified at references 102A, 102B, 102C, 102D and 102E. It will be appreciated that while five layers are shown for simplicity, LVL may be constructed using more or less layers of wood. Typically, each of the wood veneers 102A, 102B, 102C, 102D and 102E are aligned primarily along the length of the finished product. In some examples, each veneer 102A, 102B, 102C, 102D and 102E are about 0.125 inches thick and made from rotary-peeled softwood (for example, but not limited to, southern yellow pine, Douglas fir, Aspen and Norway Spruce).

Each veneer 102A, 102B, 102C, 102D and 102E is dried and graded. In most examples, the higher graded veneers are used for the face of the LVL while lesser graded veneers are arranged near the core. Once the veneers 102A, 102B, 102C, 102D and 102E are dried they are individually passed under a curtain or roll coater where resin is applied. The resin can be phenol-formaldehyde (PF) or urea-formaldehyde (UF) or other material suitable for joining the veneers 102A, 102B, 102C, 102D and 102E together. Once resin is applied to each individual veneer 102A, 102B, 102C, 102D and 102E, the veneers are arranged in a stack 110 and fed into a hot press where the stack of veneers 110 are pressed into a solid billet thereby forming the assembled LVL. In some examples the solid billets may be rip cut into numerous strips 120A, 120B according to customer specification. By way of example, some LVL strips can be formed to beam length sections having 1 and ¾ inch by 11 and ⅞ inch cross-sections. Again, the description of the method of forming assembled LVL above is merely exemplary and other methods may be used for forming the assembled LVL within the scope of the present disclosure.

With reference to FIGS. 4-6, a method of making treated LVL according to the present disclosure will be described. With initial reference to FIG. 4, the instant method includes obtaining assembled LVL, such as the LVL 120B described above with respect to FIG. 3. It is important to recognize that the instant method described herein uses pre-made LVL that has already been formed and assembled into veneers 110. Next, the veneers 120A are treated using a treating process system 200 as will be described in greater detail herein. Once the treating process 200 is complete, the treated LVL 120C is created.

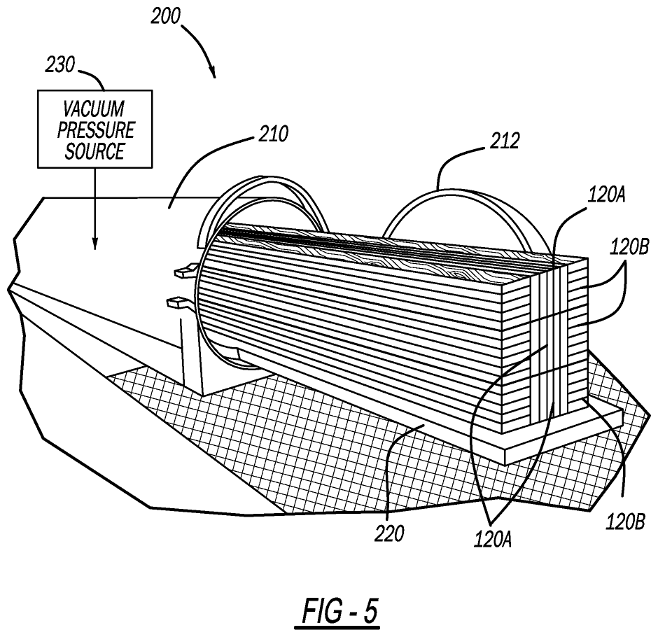

With particular reference now to FIG. 5, the treating process system 200 will be further described. The treating process system 200 can generally include a vacuum pressure chamber 210 having a door 212 that is selectively movable between open and closed positions. In the closed position, the pressure chamber 210 is air tight. A vacuum pressure source 230 is fluidly coupled to the pressure chamber 210 and configured to introduce a negative pressure (vacuum) or positive pressure into the pressure chamber 210. A tray 220 can be included for slidably advancing stacks of LVL 120A, 120B into and out of the pressure chamber 210. It will be appreciated that the vacuum pressure chamber 210 may be constructed differently within the scope of the present disclosure. It will further be appreciated that while the stacks of LVL 120A, 120B are shown in a particular arrangement and orientation in FIG. 5, they may be placed into the pressure chamber 210 in any configuration or orientation sufficient to adequately expose them to solution as explained herein.

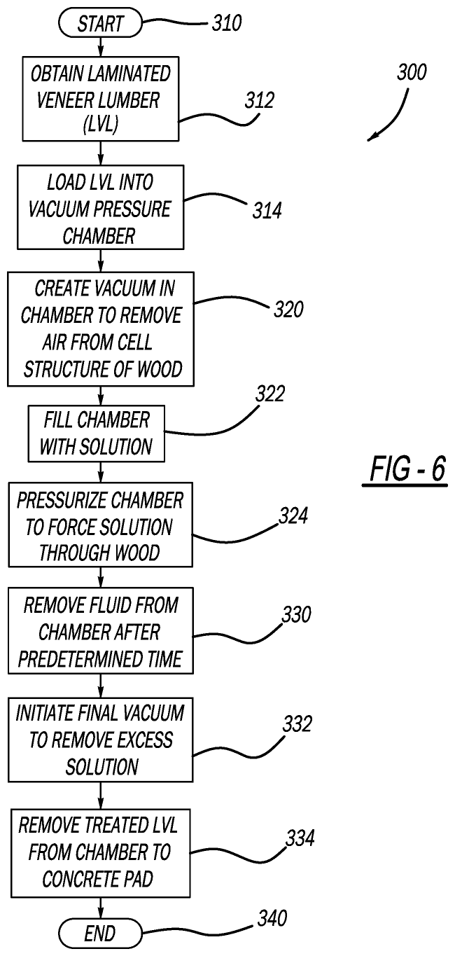

With continued reference to FIG. 5 and additional reference to FIG. 6, a method of making treated LVL will be described. The method is generally identified at reference 300 in FIG. 6. The method starts at 310. At 312 assembled LVL (such as 120A, 120B) is obtained. The assembled LVL is loaded into the vacuum pressure chamber 210 at 314. A vacuum is created in the pressure chamber 210 using the vacuum pressure source 230 at 320. The vacuum pressure can be initiated by a controller (not specifically shown) operated by a worker. The vacuum pressure is used to remove air from the cell structure of the wood.

The pressure chamber 210 is then filled with solution at 322. According to one example, the solution is inorganic solution that fully impregnates the assembled LVL with waterborne preservatives such as, but not limited to micronized copper azole (MCA), copper azole, type A and B (CA), ammoniacal copper quaternary, type B and C (ACQ), ammoniacal copper zinc arsenate (ACZA) and chromatid copper arsenate, type A, B and C (CCA). In still other examples, the inorganic solution can additionally or alternatively include other vacuum pressure waterborne inorganic chemicals. Next, the pressure chamber 210 is pressurized to force the solution through the assembled LVL at 324. The pressure chamber 210 is pressurized for an amount of time required to sufficiently penetrate the solution through the thickness of the LVL. In some examples, the LVL is pressurized for greater than 30 minutes, such as 35 minutes to ensure full penetration of the solution through the thickness of the LVL. In other examples, the LVL can be successfully penetrated through the thickness of the LVL during pressure treatment in less time, such as but not limited to, 6 minutes. After the assembled LVL has been submerged with solution and pressurized for a period of time, the solution is removed (drained) from the pressure chamber 210 at 330. In some examples the solution is returned back to a work tank where it can be used again. At 332 a final vacuum is introduced to the vacuum chamber 210 to remove excess solution. The treated LVL 120C is then removed from the vacuum chamber 210 at 334. In some examples the treated LVL 120C can be placed on a concrete pad for a designated amount of time. The method ends at 340.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A method of making treated laminated veneer lumber (LVL), the method comprising:
obtaining assembled LVL, the assembled LVL comprising a plurality of layers of veneer wood assembled together with adhesive;
loading the LVL into a pressure chamber;
creating a vacuum in the pressure chamber thereby removing air from the plurality of layers of veneer wood of the LVL;
adding inorganic solution to the pressure chamber; and
pressurizing the pressure chamber to force inorganic solution into the wood creating the treated LVL.

2. The method of claim 1, further comprising:
waiting a predetermined amount of time subsequent to pressurizing the pressure chamber to allow the inorganic solution to absorb into the LVL.

3. The method of claim 2 wherein the predetermined amount of time is at least 6 than minutes.

4. The method of claim 3 wherein the predetermined amount of time is greater than 30 minutes.

5. The method of claim 3, further comprising:
removing the inorganic solution from the pressure chamber subsequent to waiting the predetermined amount of time.

6. The method of claim 5, further comprising:
creating a vacuum in the pressure chamber subsequent to removing the inorganic solution from the pressure chamber.

7. The method of claim 6, further comprising:
removing the treated LVL from the pressure chamber; and
placing the treated LVL onto concrete pad for drying.

8. The method of claim 1 wherein adding the inorganic solution comprises:
adding a solution that includes at least one of micronized copper azole (MCA), copper azole (CA), ammoniacal copper quaternary (ACQ), ammoniacal copper zinc arsenate (ACZA) and chromatid copper arsenate (CCA).

9. The method of claim 8 wherein adding the inorganic solution comprises adding all of MCA, CA, ACQ, ACZA and CCA.

10. Treated laminated veneer lumber (LVL) comprising:
assembled LVL treated with an inorganic solution in a pressure chamber wherein the inorganic solution is penetrated through an entire thickness of the assembled LVL.

11. The treated LVL wherein the inorganic solution comprises a solution that includes at least one of micronized copper azole (MCA), copper azole (CA), ammoniacal copper quaternary (ACQ), ammoniacal copper zinc arsenate (ACZA) and chromatid copper arsenate (CCA).

12. The treated LVL of claim 11 wherein the inorganic solution comprises all of MCA, CA, ACQ, ACZA and CCA.

13. The treated LVL of claim 12 wherein the CA comprises type A and B CA.

14. The treated LVL of claim 12 wherein the ACQ comprises type B and C ACQ.

15. The treated LVL of claim 12 wherein the CCA comprises type A, B and C CCA.
